(19) United States
(12) Patent Application Publication
(10) Pub. No.: US 2010/0215205 A1
(43) Pub. Date: Aug. 26, 2010

(54) Audio Playback Apparatus and Stand for Display Apparatus

(75) Inventors: Yoshikazu Nagao, Shizuoka (JP); Michiaki Hamada, Tokyo (JP); Kanya Matsumoto, Tokyo (JP); Shirokazu Yazaki, Tokyo (JP)

Correspondence Address: FOLEY AND LARDNER LLP;SUITE 500, 3000 K STREET NW, WASHINGTON, DC, 20007, US

(73) Assignee: PIONEER CORPORATION PIONEER DISPLAY PRODUCTS CORPORATION

(21) Appl. No.: 12/085,345

(22) PCT Filed: Dec. 13, 2006
(86) PCT No.: PCT/JP2006/324829

§ 371 Date: May 22, 2008

(30) Foreign Application Priority Data
Dec. 13, 2005 (JP) 2005-359013

(51) Int. Cl. H04R 1/02

(52) U.S. Cl. 381/388; 381/386

(57) ABSTRACT

An audio playback apparatus and a stand for a display apparatus include frame members, speakers attached to the frame members, a baffle plate for the speakers, and baffle panels attached to the frame members. Further, the baffle panels are attached to the frame members such that the baffle panels and the baffle plate are substantially in the same plane.

### TECHNICAL FIELD

The present invention relates to an audio playback apparatus that plays back audio such as that of a CD and a DVD, and a stand on which a display apparatus is set.

### BACKGROUND ART

In general, system furniture for an audio playback apparatus provided in an audio-visual room, a home theater, and the like, is attached to a wall of a room by installation work.

### DISCLOSURE OF INVENTION

### Problem to be Solved by the Invention

However, the above conventional technique has a problem in that significant construction work is required to install, move, and remove a system; hence, not only is it difficult to install, move, and remove the system, but it is also difficult to modify the system. Additionally, since the wall becomes damaged, repair is required upon removal of the system. Therefore, there is a problem in that, in some cases, installation is not possible unless the house is owned by a user and is difficult in the case of an apartment (particularly, a rental apartment).

Furthermore, the above conventional technique has another problem in that since independent systems are combined, a sound field is difficult to set and cannot be changed easily. The above conventional technique has another problem in that each device is embedded in some cases, and the dissipation of heat generated from the devices is difficult, thereby causing harm to each device.

### Means for Solving Problem

An audio playback apparatus according to the invention of claim 1 includes a frame member; a speaker attached to the frame member; a baffle plate for the speaker; and a panel member attached to the frame member.

A stand for a display apparatus according to the invention of claim 10 includes a frame member to which a display apparatus, a speaker, and a baffle plate for the speaker can be attached; and a panel member attached to the frame member.

### BRIEF DESCRIPTION OF DRAWINGS

FIG. 1 is an explanatory (perspective) view of a configuration of frame members of an audio playback apparatus according to an embodiment of the present invention;

FIG. 2-1 is an explanatory (perspective) view of a state upon a mounting of a side speaker to a frame member of the audio playback apparatus according to the embodiment of the present invention;

FIG. 2-2 is an explanatory (perspective) view of a rear of the side speaker;

FIG. 3-1 is an explanatory (perspective) view of a state upon a mounting a front speaker to the frame member of the audio playback apparatus according to the embodiment of the present invention;

FIG. 3-2 is an explanatory (perspective) view of a rear of a center speaker;

FIG. 4 is an explanatory (perspective) view of a configuration of housing members of the audio playback apparatus according to the embodiment of the present invention;

FIG. 5 is an explanatory (perspective) view of a rear configuration of the housing members of the audio playback apparatus according to the embodiment of the present invention;

FIG. 6 is an explanatory (perspective) view of a configuration of panel members of the audio playback apparatus according to the embodiment of the present invention;

FIG. 7 is an explanatory (perspective) view of another configuration of the panel members of the audio playback apparatus according to the embodiment of the present invention;

FIG. 8 is an explanatory (perspective) view of a configuration of a center cabinet of the housing member of the audio playback apparatus according to the embodiment of the present invention;

FIG. 9 is an explanatory (perspective) view of a rear configuration of the center cabinet of the housing member of the audio playback apparatus according to the embodiment of the present invention;

FIG. 10 is an explanatory (front) view of an entire audio playback apparatus according to an example of the present invention;

FIG. 11 is an explanatory (front) view of a configuration of frame members corresponding to FIG. 10 and a display apparatus; and

FIG. 12 is an explanatory (side) view of the entire audio playback apparatus according to the example of the present invention.

### EXPLANATIONS OF LETTERS OR NUMERALS

101, 102, 103, 104 frame
105 caster
201 baffle plate (for side (right) speaker)
202 baffle plate mounting
203, 204 side-speaker mounting hole
205 side speaker box
206 side-speaker rear plate
301 baffle plate (for center speaker)
302 baffle plate mounting
303, 304, 305, 306, 307 center-speaker mounting hole
308 center speaker box
309 cord hole
401 top plate
402 low-frequency speaker box (left)
403 low-frequency speaker box (right)
404 center cabinet
405 door for center-cabinet (left)
406 door for center-cabinet (right)
407 low-frequency speaker cover (left)
408 low-frequency speaker cover (right)
409 caster
410 leg
501, 901, 903 rear cover for center cabinet
601-605, 701-705 baffle panel
606, 706 center speaker cover
607, 608, 707, 708 side speaker cover
609, 709 space for display apparatus
610 hook and loop fastener (registered trademark)
801, 803 front cover for center cabinet
802, 804 sliding table
805 in-cabinet rack
902, 904 rear cover hole
1000 audio playback apparatus
1001 display apparatus

### BEST MODE(S) FOR CARRYING OUT THE INVENTION

With reference to the accompanying drawings, exemplary embodiments of an audio playback apparatus according to the present invention are explained in detail below.

### (Configuration of Frame Member of Audio Playback Apparatus)

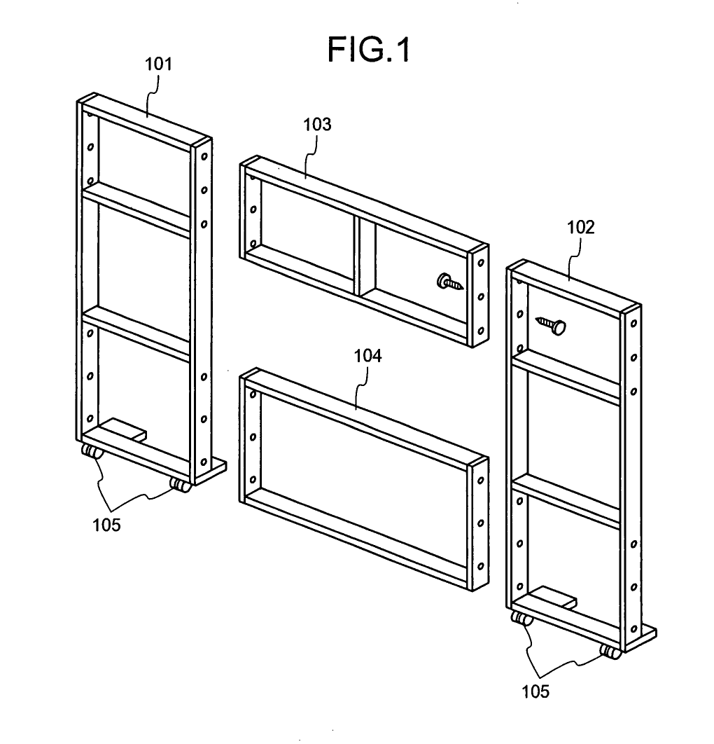

FIG. 1 is an explanatory (perspective) view of a configuration of frame members of the audio playback apparatus according to an embodiment. As shown in FIG. 1, for example, the audio playback apparatus according to the embodiment of the present invention is formed by four frames (a left frame 101, a right frame 102, a top frame 103, and a bottom frame 104). However, configuration is not limited to these grid-like frames.

Each frame can be assembled with a screw, for example. Thus, plural frames are assembled to constitute one frame. Each of the frames 101 to 104 is made of steel, for example. Specifically, for example, a square pipe of 40 mm×25 mm is used for each of the frames 101 to 104.

Unlike an audio playback apparatus nailed to a wall, the audio playback apparatus according to the embodiment is disposed by a wall without modification of the wall. Casters 105 are provided on the bottom of the frames of the audio playback apparatus according to the embodiment, enabling the frames 101 to 104 that are assembled to be moved. As a result, even after the audio playback apparatus is installed, the installation location can be easily moved. The frames 101 to 104 can be fixed at a predetermined location by an attachment of a non-depicted adjuster.

As shown in FIG. 1, a space at the center of the four frames 101 to 10 can be formed by an assembly thereof. This space is for mounting a display apparatus 1001 explained hereinafter. A low-frequency speaker box (left) 402, a low-frequency speaker box (right) 403, and a center cabinet 404 that are explained hereinafter are connected on the lower side of the frames 101 and 102, and on the frame 104, respectively.

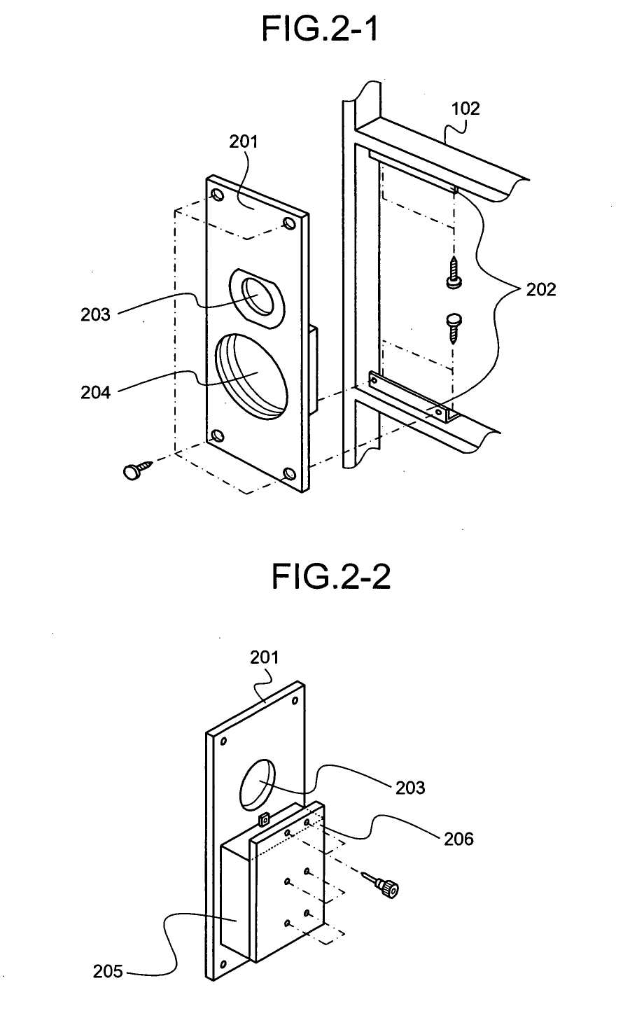

FIG. 2-1 is an explanatory (perspective) view of a state upon a mounting of the side speaker to the frame member of the audio playback apparatus according to the embodiment. As shown in FIG. 2-1, a reference character 201 represents a baffle plate (for a right speaker) of a non-depicted side speaker, and a reference character 202 represents a baffle plate mounting that mounts the baffle plate 201 to the frame 102. Reference characters 203 and 204 represent side-speaker mounting holes provided in the baffle plate 201 for mounting the speakers.

Speakers (not shown) of given diameters are respectively fit and mounted in the side-speaker mounting holes 203 and 204. Specifically, for example, the baffle plate mounting 202 is a bracket. When the baffle plate 201 is mounted to the frame 102, a surface of the baffle plate 201 can be fixed in substantially the same plane as a front surface of the frame 102. Alternatively, the surface of the baffle plate 201 can be fixed in a position protruding from the front surface of the frame by a thickness of a baffle panel explained hereinafter.

The position of the baffle plate 201 is one characteristic of the audio playback apparatus according to the embodiment. The baffle plate 201 is configured such that the baffle plate 201 and baffle panels 601 to 605 explained hereinafter are in substantially the same plane, in other words, such that there is no protrusion or recess thereamong, thereby the baffle plate 201 and the baffle panels 601 to 605 function as one baffle plate. As a result, baffle effect can be maximally achieved, and a highly realistic sound can be created even at a low volume. Additionally, an optimal range of a sound field increases, thereby eliminating a strict setting of the sound field.

FIG. 2-2 is an explanatory (perspective) view of a rear of the side speaker. As shown in FIG. 2-2, a reference character 205 represents a side-speaker box in which a fixed speaker (not shown) is to be housed. A reference character 206 represents a side-speaker rear plate. Thus, to keep sounds leaking behind the speaker to a minimum, the side speaker is housed in the side speaker box 205, and the side-speaker rear plate 206 is screwed thereto, thereby enhancing sealing.

Although not shown, similar to FIGS. 2-1 and 2-2, a baffle plate for the left speaker is mounted to the frame 103 such that the baffle plate and the baffle panels 601 to 605 are in substantially the same plane, i.e., such that there is no protrusion or recess thereamong.

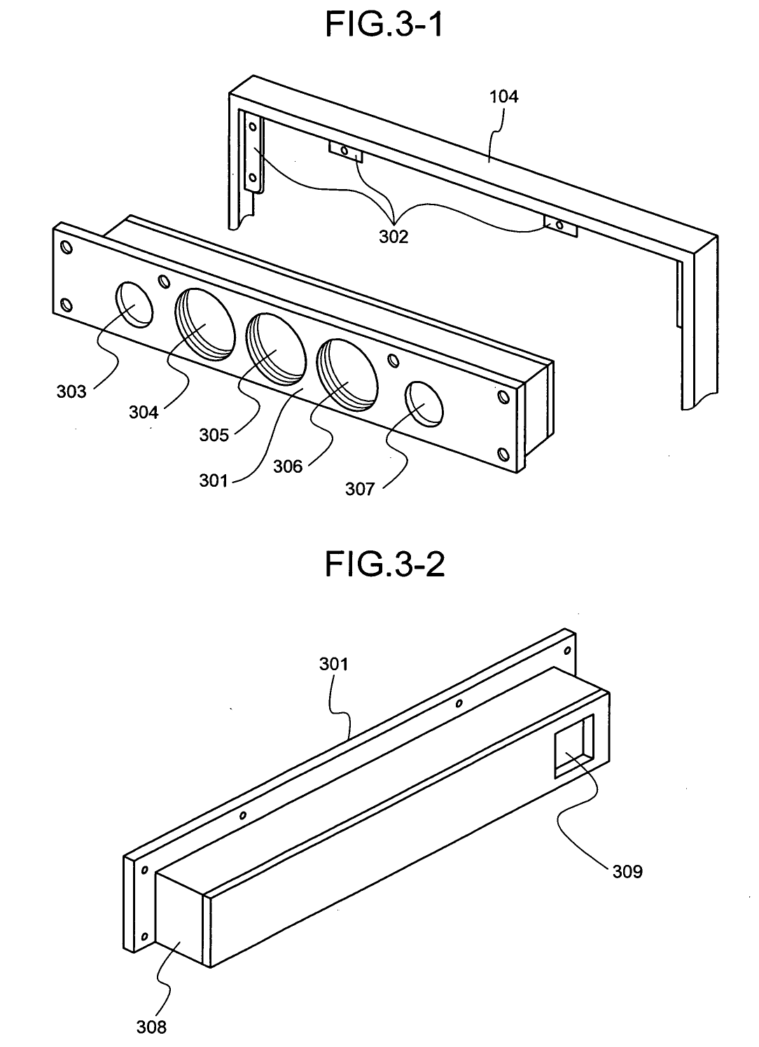

FIG. 3-1 is an explanatory (perspective) view of a state upon a mounting of a front speaker to the frame member of the audio playback apparatus according to the embodiment of the present invention. As shown in FIG. 3-1, a reference character 301 represents a baffle plate for a non-depicted center speaker, and a reference character 302 represents a baffle plate mounting that mounts the baffle plate 301 to the frame 104. Reference characters 303 to 307 represent center-speaker mounting holes provided in the baffle plate 301 for mounting speakers.

Speakers (not shown) of given diameters are fit and mounted in the center-speaker mounting holes. Specifically, for example, the baffle plate mounting 302 is a bracket. When the baffle plate 301 is mounted to the frame 104, a surface of the baffle plate 401 is fixed in substantially the same plane as a front surface of the frame 104. Alternatively, the surface of the baffle plate 301 is fixed on a position protruding from the front surface of the frame by a thickness of a baffle panel explained hereinafter.

FIG. 3-2 is an explanatory (perspective) view of a rear of the center speaker. As shown in FIG. 3-2, a reference character 308 represents a center speaker box in which the attached center speakers (not shown) are housed. Thus, to keep sounds leaking behind the speakers at minimum, the center speaker is housed in the center speaker box 308, thereby enhancing sealing. A reference character 309 represents a cord exit hole.

### (Configuration of Housing Members of Audio Playback Apparatus)

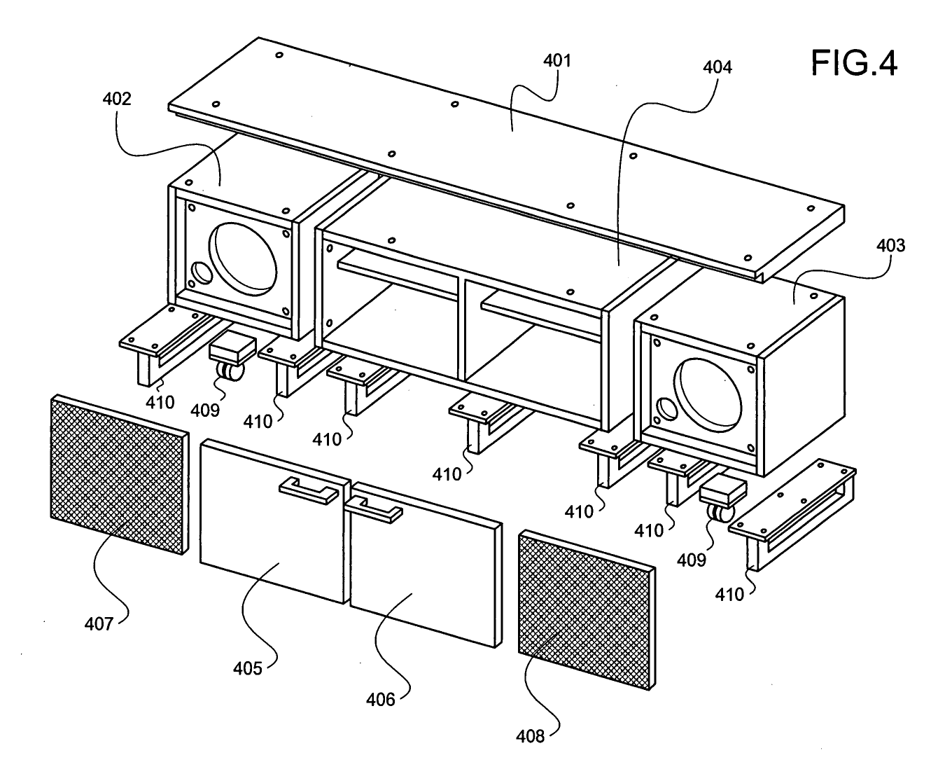

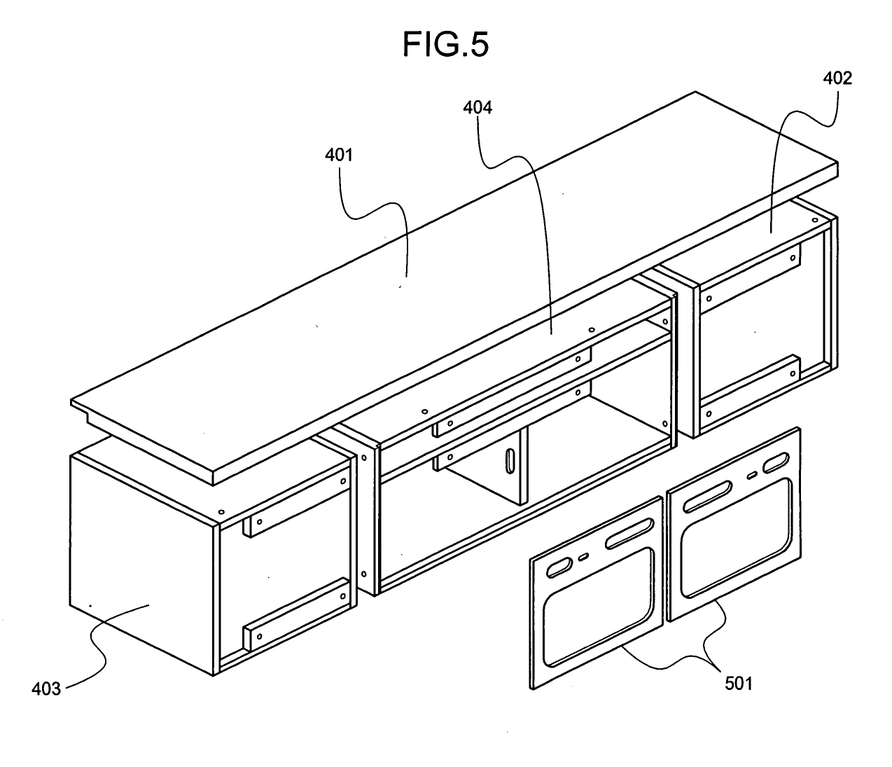

FIG. 4 is an explanatory (perspective) view of a configuration of housing members (furniture) of the audio playback apparatus according to the embodiment of the present invention. FIG. 5 is an explanatory (perspective) view of a rear configuration of the housing members of the audio playback apparatus according to the embodiment of the present invention. As shown in FIG. 4, a reference character 401 represents a top plate, a reference character 402 represents a low-frequency speaker box (left), a reference character 403 represents a low-frequency speaker box (right), a reference character 404 represents a center cabinet, a reference character 405 represents a door for the center cabinet (left), a reference character 406 represents a door for the center cabinet (right), a reference character 407 represents a low-frequency speaker cover (left), a reference character 408 represents a low-frequency speaker cover (right), a reference character 409 represents a caster, and a reference character 410 represents a leg. As shown in FIG. 5, a reference character 501 represents a rear cover for the center cabinet.

The low-frequency speaker cover not only prevents dust from entering, but also serves to hide the speakers. In other words, it is considered to be preferable for the speakers to not be visible since the audio playback apparatus according to the embodiment functions as a part of a wall in a room (interior furnishing). Therefore, a color or a material of the cover may be selected according to the interior decor of the room.

Left and right low-frequency speakers (not shown) are housed in the low-frequency speaker box (left) 402 and the low-frequency speaker box (right) 403, respectively. A media playback apparatus is housed in the center cabinet 404. Media playback apparatuses include amplifiers, tuners (for televisions and radios), set-top boxes for cable television, Internet connection apparatuses, CD playback apparatuses, a DVD playback apparatuses, and the like.

The door for the center cabinet (left) 405 and the door for the center cabinet (right) 406 are attached to the center cabinet 404, and can be opened and closed as double-doors. The doors for the center cabinet are not limited to double-doors and, for example, may be laterally sliding doors (not shown), for example. In this case, for example, the door is not in the way when a user approaches the center cabinet 404 using a wheelchair to manipulate the apparatus. Additionally, it is preferable if the sliding door can be automatically opened and closed with a remote controller, as convenience in use improves and a sumptuous quality is imparted.

The low-frequency speaker covers 407 and 408 are detachably attached to the low-frequency speaker boxes 402 and 403, respectively. The low-frequency speaker covers 407 and 408 are formed, for example, of a material (such as, cloth) that prevents dust from entering without blocking the sound from the speakers.

The low-frequency speaker boxes 402 and 403 are respectively connected to the center cabinet 404 with screws, etc., such that the center cabinet 404 is disposed between the low-frequency speaker boxes 402 and 403, and the top plate 401 is fixed thereon with a screw, etc. The caster 409 is provided on each of the low-frequency speaker boxes 402 and 403. Although not shown, the caster 409 may be provided on the center cabinet 404. A leg 410 is provided on each of the low-frequency speaker boxes 402 and 403 and the center cabinet 404, which fixes the positions of the low-frequency speaker boxes 402 and 403, and the center cabinet 404.

### (Configuration of Panel Members of Audio Playback Apparatus)

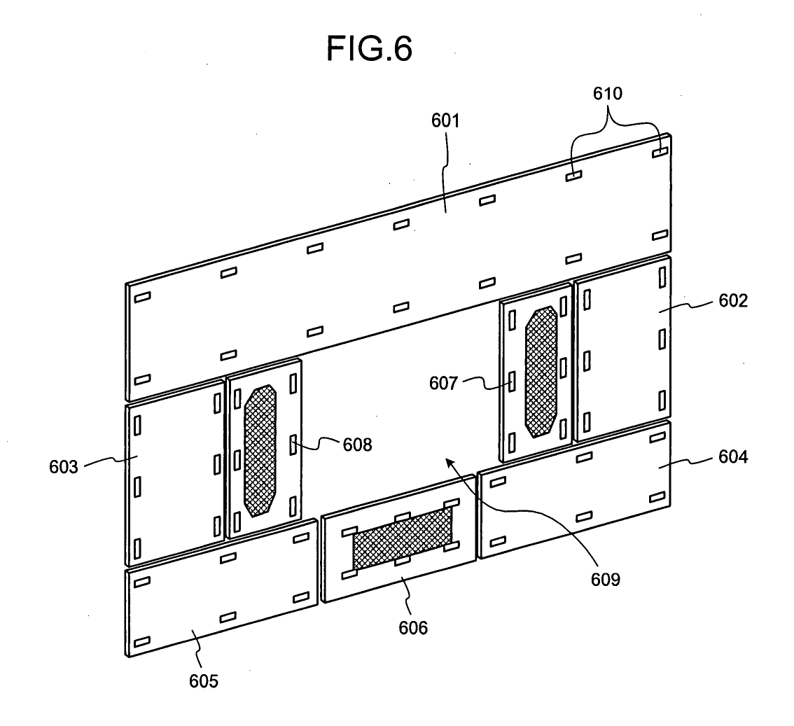

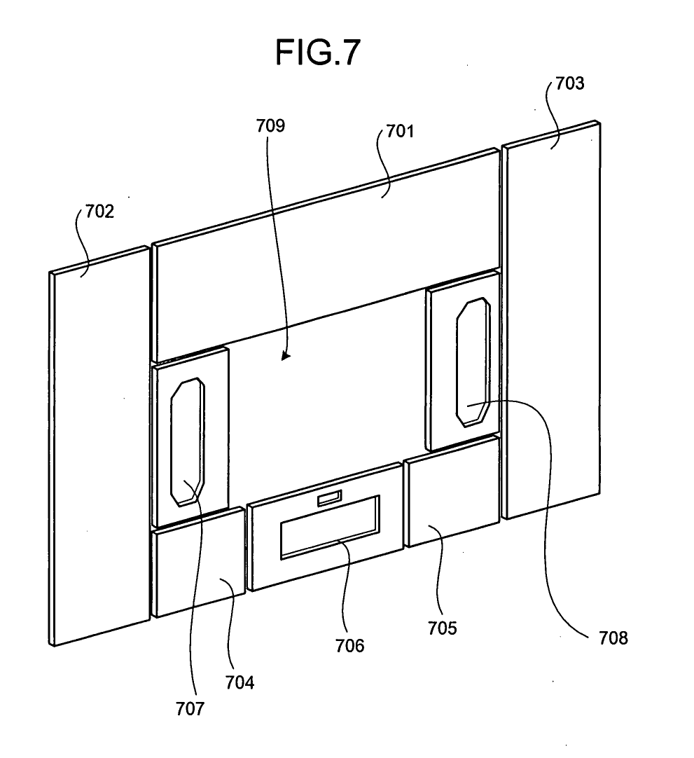

FIG. 6 is an explanatory (perspective) view of a configuration of the panel members of the audio playback apparatus according to the embodiment of the present invention. FIG. 7 is an explanatory (perspective) view of another configuration of the panel members of the audio playback apparatus according to the embodiment of the present invention. FIG. 6 is a rear view of the panel members.

As shown in FIG. 6, reference characters 601 to 605 represent baffle panels, a reference character 606 represents a center speaker cover, a reference character 607 is a side speaker cover (left), and a reference character 608 represents a side speaker cover (right). A reference character 609 is a space for a display apparatus. As shown in FIG. 7, reference characters 701 to 705 are baffle panels, a reference character 706 is a center speaker cover (left), a reference character 707 is a side speaker cover (right), a reference character 708 is a side speaker cover (left), and a reference character 709 is a space for a display apparatus. The baffle panels are attached to the frames, thereby constituting a wall unit.

A reference character 610 represents a hook and loop fastener (registered trademark). The baffle panels 601 to 605 and the speaker covers 606 to 608 are easily detached from the frame members by using the hook and loop fasters. The baffle panels 601 to 605 may be attached with a member different from the hook and loop fastener.

It is desirable that the baffle panels 601 to 605 be boards made of wood such as that used for a musical instrument to achieve a resonance effect. Color and design may be changed according to the space for installation. It is most preferable that the baffle panels be constituted by one panel. However, with consideration of flexibility of the material, manufacturing, and conveyance, the baffle panels are divided into plural panels 601 to 605. The division method is not limited to the method shown in FIG. 6 and may be, for example, the method shown as the baffle panels 701 to 705 in FIG. 7.

The formation of the baffle panels 601 to 605 or 701 to 705, and the baffle plates 201 and 301 in the same plane, enables the baffle plates 201 and 301, and the baffle panels 601 to 605 or 701 to 705 to form one large baffle plate, thereby more effectively providing a baffle effect. As a result, highly realistic sounds can be played back without turning up the volume.

### (Detailed Configuration of Center Cabinet)

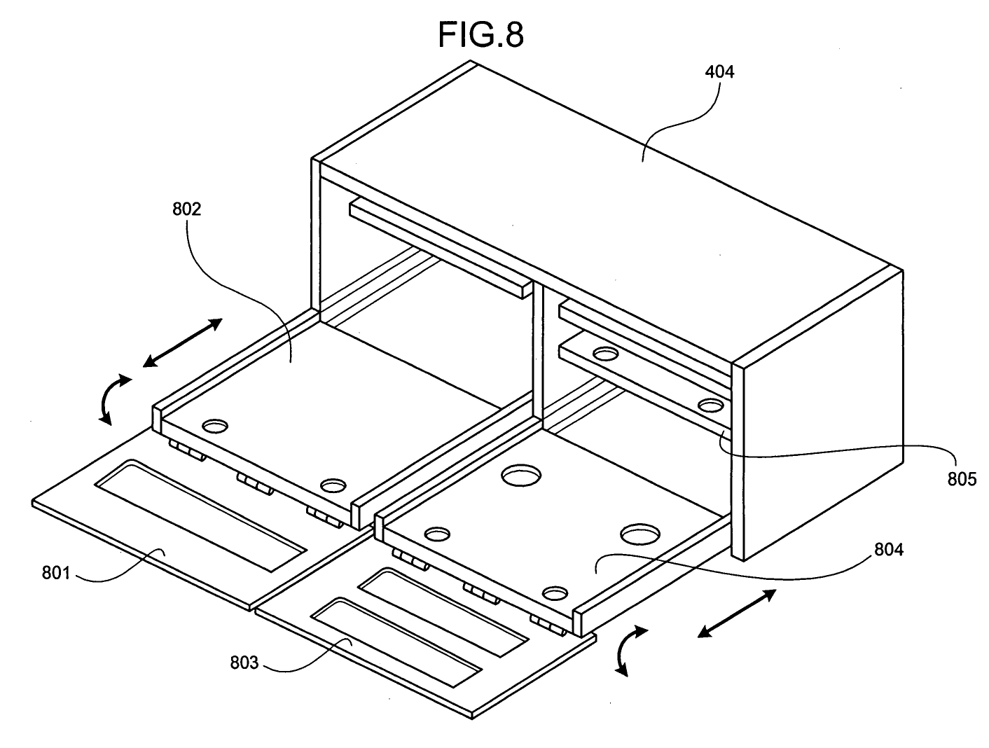

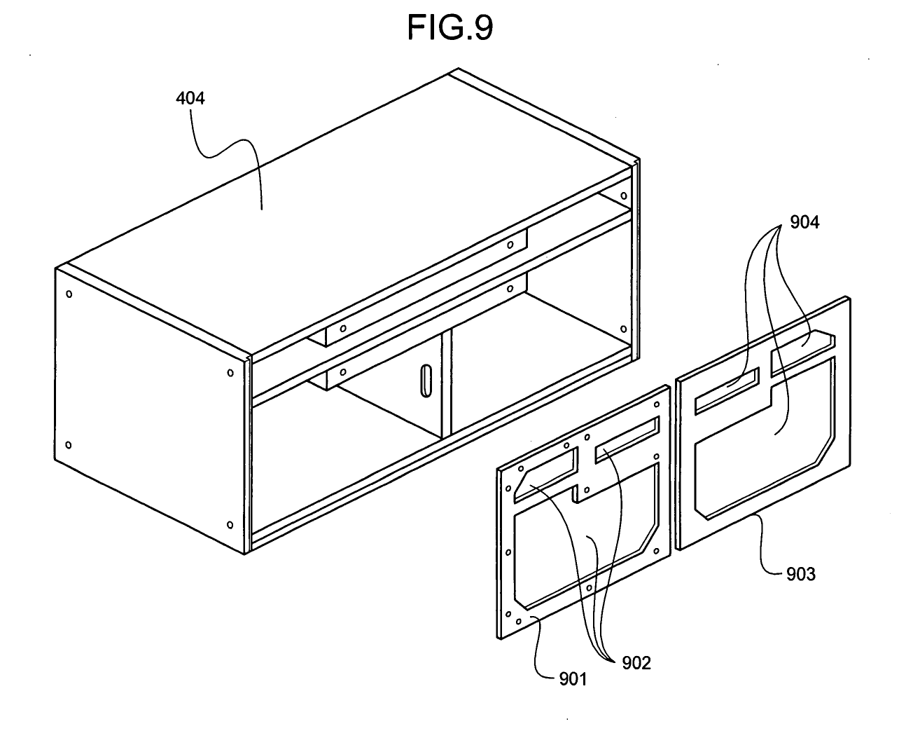

FIG. 8 is an explanatory (perspective) view of a configuration of the center cabinet of the housing member (furniture) of the audio playback apparatus according to the embodiment of the present invention. FIG. 9 is an explanatory (perspective) view of a rear configuration of the center cabinet of the housing member of the audio playback apparatus according to the embodiment of the present invention. As shown in FIG. 8, reference characters 801 and 803 represent front covers for the center cabinet, reference characters 802 and 804 represent sliding tables, and a reference character 805 represents an in-cabinet rack. As shown in FIG. 9, a reference character 901 represents a rear cover for the center cabinet, and reference characters 902 and 904 represent rear cover holes.

The media playback apparatus (a tuner, an amplifier, a DVD playback apparatus, a CD playback apparatus, etc.) is disposed on the side table 802 or 804. To dispose the media playback apparatus stably, indentations corresponding to the feet of the media playback apparatus (each component) are provided on the sliding tables 802 and 804. Thus, each component can be easily drawn out. As a result, attachment of the front covers 801 and 803 for the center cabinet explained hereinafter is easily performed without consideration of the combination of respective components or adjustment of the component combination.

The media playback apparatus disposed on the side table 802 or 804 is housed in the center cabinet 404 by a sliding of the side table 802 or 804. Similarly, the media playback apparatus is drawn out from the center cabinet 404 by a sliding of the slide table 802 or 804. With such a configuration, housing and drawing out of the media playback apparatus can be easily performed.

Upon housing of the media playback apparatus, the front cover 801 or 803 for the center cabinet is stood in the direction indicated by an arrow, thereby preventing dust from entering, and underscoring a good appearance. Specifically, the front covers for the center cabinet may include a translucent acrylic plate.

Holes are provided on the front covers for the center cabinet 801 and 803 according to a shape of the media playback apparatus (a disc insertion slot, an operation button, a design of a display) so that the media playback apparatus can be manipulated even when the front covers for the center cabinet 801 and 803 are closed. The in-cabinet rack is provided, thereby enabling plural media playback apparatuses to be housed in either side. The in-cabinet rack 805 may be slidable.

As shown in FIG. 9, plural rear cover holes 902 to 904 are provided in a rear cover for the center cabinet 901 to enhance the dissipation of heat from the media playback apparatus. The heat passing through the rear cover holes 902 to 904 passes through the back of the baffle panels 601 to 605 or 701 to 705 (frame side), and is released from the upper side of the frames.

### EXAMPLE

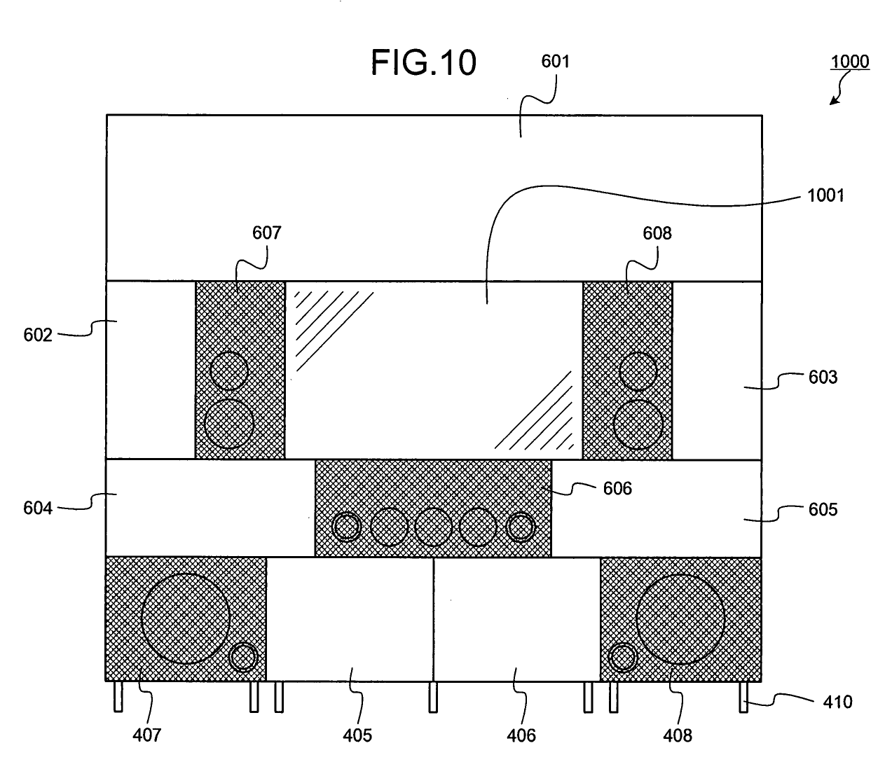

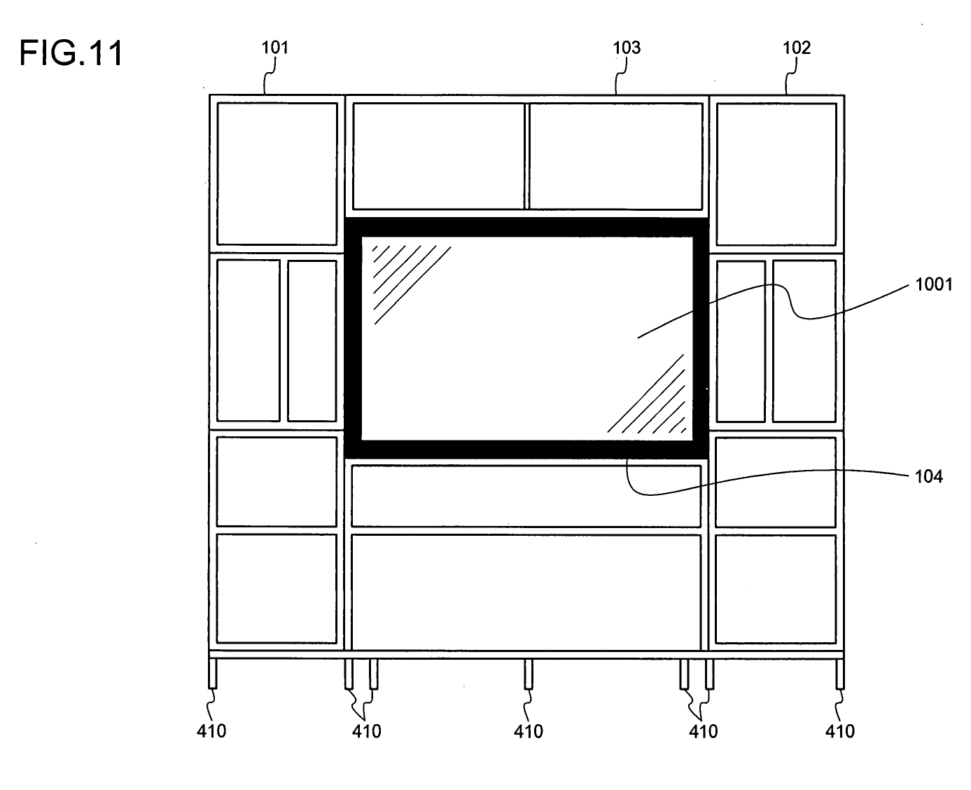

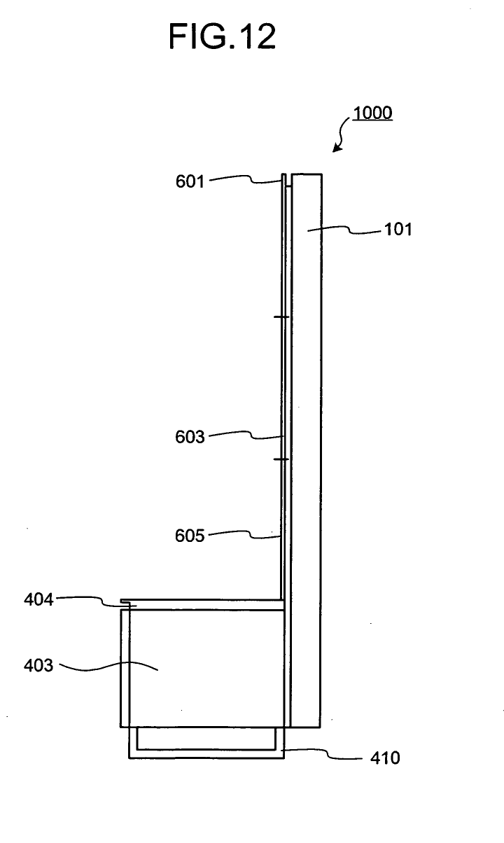

FIG. 10 is an explanatory (front) view of an entire audio playback apparatus according to an example. FIG. 11 is an explanatory (front) view of a configuration of the frame members corresponding to FIG. 10 and a display apparatus. FIG. 12 is an explanatory (side) view of the entire audio playback apparatus according to the example.

As shown in FIG. 10, an audio playback apparatus 1000 according to the example is 2400 mm wide and 2100 mm high. The baffle panel 601 is 2400 mm wide and 588 mm long. The baffle panels 602 and 603 are 324 mm wide and 624 high. The baffle panels 604 and 605 are 775 mm wide and 348 mm high. The center cabinet 404 (the door for the center cabinet 405 and 406) is 1200 mm wide and 404 mm high. The low-frequency speaker boxes 402 and 403 (low-frequency speaker covers 407 and 408) are 600 mm wide and 404 mm high.

As shown in FIG. 11, a plasma display 1101 of 50 inches is disposed on the space 609. A display surface of the plasma display 1101 functions as a part of the baffle plate. Therefore, entire baffle panels 601 to 605 including the plasma display 1101 can be flat. A reference character 1101 is not limited to the plasma display, but may be a large flat-screen television such as a liquid crystal television and a rear-projection television.

As shown in FIG. 12, the center cabinet 404 is 580 mm deep, and the frame member 101 is 125 mm deep. The leg 410 is 100 mm high. The top plate 401 is 9 mm deep.

The plasma display 1101 may be fit onto the frame with a flip-up mechanism, which enables detachment of the plasma display 1101 from the front side, and eliminating subtle displacement with the plasma display 1101 being held. As a result, the position of the entire audio playback apparatus need not be moved to exchange the plasma display 1101.

As shown in FIG. 12, the rear of the baffle panel has a frame configuration having many spaces between frames, a chimney configuration, enabling heat from the media playback apparatus in the center cabinet 404 to be released. As a result, the problem of dissipating heat while being acoustically sealed can be solved. It is preferable in terms of heat dissipation to use a digital amplifier, which enables the frame portion and the housing members (furniture) to be thinner. Additionally, wiring can be hidden in the space between frames.

A middle-to-high frequency speaker is disposed on a thin portion, and the low-frequency speaker is disposed on a lower portion, thereby enabling a balance of sound to be maintained. The housing members are provided on the lower portion, thereby enabling the large frame to be stable. With enlargement of the entire audio playback apparatus according to the embodiment, a distance between the positions from which the middle-to-high frequency sound and the low frequency sound are respectively output and the position of a listener differs, causing a phase difference in some cases. The phase difference can be easily removed by using a digital amplifier that is preferable in terms of the dissipation of heat.

Although not shown, if a light is provided around the audio playback apparatus, as an interior furnishing, the value of the audio playback apparatus can be increased.

If the display apparatus, the speaker, the baffle plate for the speaker, and the media playback apparatus are excluded, a stand for a display apparatus, i.e., a television stand can be achieved. The television stand may include only a wall unit, and may include the wall unit (the frame, the speaker, the baffle plate, and the baffle panel) and the housing members.

As explained above, according to the embodiment, the frames 101 to 104, the speakers attached to the frames 101 to 104, and the baffle plate 201 for the speaker, and the baffle panels 601 to 605 attached to the frames are included, and the baffle panels 601 to 605 are attached to the frames such that the baffle panels 601 to 605 and the baffle plate 201 are in substantially the same plane. As a result, the baffle plates 201, the baffle panels 601 to 605, and the display apparatus (the plasma display 1101) form substantially the same plane, and are disposed without a space therebetween, thereby enhancing the baffle effect and providing an audio playback apparatus with excellent sound.

The baffle panels 601 to 605 are detachably attached to the frames 101 to 104. The baffle panels 601 to 605 include plural panels (601 to 605 or 701 to 705), and are detachably attached to the panels, respectively.

The plasma display 1101 is included that is attached to the frames 101 to 104 such that the surface of the plasma display 1101 and the baffle plate 201 are in substantially the same plane. The caster 105 for enabling the frames 101 to 104 to be moved is also included.

The housing members connected with the frame members are included, and house the low-frequency speaker and the medium playback device. As a result, an effect of providing an audio playback apparatus with excellent audio quality that can be easily installed and removed. In other words, since each device is provided separately in a typical audio playback system, it has been difficult to achieve a similar sound field as felt at a store. However, the above audio playback apparatus can achieve a similar sound field as felt at the store without difficulty, and the installation thereof is simple.

Specifically, ensured strength of the configuration and reduction in weight is achieved. In other words, a square pipe is used for a configuration of the wall unit, which is directly connected to the rear surface of the housing members, achieving the reduction in weight of the entire audio playback apparatus according to the embodiment, and ensuring the strength of the configuration of the entire audio playback apparatus according to the embodiment.

Additionally, easiness of movement and conveyance of the audio playback apparatus by the division is achieved. In other words, the size of the housing members is reduced by being divided into three divided configurations, including the center cabinet 404 and the left and the right low-frequency speaker boxes 402 and 403, thereby enhancing the easiness of the movement and the conveyance.

The top plate 401, the door for the center cabinet 405 and 406, the wall plates (the baffle panels 601 to 605), a grill (the low-frequency speaker covers 407 and 408, the center speaker covers 606 and 706, the side speaker covers 607, 608, 707, and 708), and the side plate are configured to be attached later, thereby enabling color coordination among multiple colors.

Since rear connection of the housing members is used upon the connection of the wall unit and the housing member(s), there is no assembly hole on an external surface (the top plate or the side plate). Therefore, an appearance of a single housing member can be improved, and the single housing member can be purchased.

For the frames, the square pipe and the bracket are not directly welded, but a screw is used. Additionally, plural holes are provided on the frame side of the square pipe, thereby enabling the bracket to be easily moved. As a result, different units can be attached with an identical mounting, thereby enhancing assembly versatility.

1-11. (canceled)

12. An audio playback apparatus comprising:
a frame member formed by an assembly of a plurality of grid-like frames;
a speaker attached to the frame member;
a baffle plate that is for the speaker and attached to the frame member; and
a panel member attached to the frame member.

13. The audio playback apparatus according to claim 12, wherein the panel member is attached to the frame member such that the panel member and the baffle plate are substantially in a single plane.

14. The audio playback apparatus according to claim 12, wherein the panel member is detachably attached to the frame member.

15. The audio playback apparatus according to claim 14, wherein the panel member is formed of a plurality of panels, and each of the panels are detachably attached.

16. The audio playback apparatus according to claim 12, further comprising a display apparatus attached to the frame member.

17. The audio playback apparatus according to claim 16, wherein the display apparatus is attached to the frame member such that a surface of the display apparatus and the baffle plate are substantially in a single plane.

18. The audio playback apparatus according to claim 12, further comprising a caster that enables the frame member to be moved.

19. The audio playback apparatus according to claim 12, further comprising a housing member connected with the frame member.

20. The audio playback apparatus according to claim 19, wherein a low-frequency speaker and a media playback device are housed in the housing member.

21. A stand for a display apparatus comprising:
a frame member that is formed by an assembly of a plurality of grid-like frames and to which a display apparatus, a speaker, and a baffle plate for the speaker can be attached; and
a panel member attached to the frame member.

22. The stand for a display apparatus according to claim 21, further comprising a housing member connected with the frame member and capable of housing a media playback device.
